(19) United States
(12) Patent Application Publication
(10) Pub. No.: US 2007/0088588 A1
(43) Pub. Date: Apr. 19, 2007

(54) Method, apparatus and network for renting textbooks

(76) Inventor: Theodore Schaffer, Chicago, IL (US)

Correspondence Address: THE LAW FIRM OF MICHAEL R. MCKENNA, 500 WEST MADISON ST., SUITE 3800, CHICAGO, IL, 60661, US

(21) Appl. No.: 11/251,725

(22) Filed: Oct. 17, 2005

(51) Int. Cl. G06F 9/46

(52) U.S. Cl. 705/8

(57) ABSTRACT

A method and apparatus for transacting a commercial rental of textbooks and other items between independent suppliers and independent users by a facilitator that does not generally maintain an inventory of the items for rent and without requiring a subscription with the users.

### BACKGROUND OF THE INVENTION

This invention relates to renting an item, such as a textbook, through a facilitator. The facilitator preferably has no inventory and requires no subscriptions for its service. In one embodiment, the facilitator utilizes an interactive internet website to bring together, in a rental transaction, an independent book possessor and an independent student for renting a textbook. Renting as used in this application is defined as a user obtaining use of an item for a period of time in return for a payment. The payment may be made in installments.

As reported in the New York Times on Sep. 16, 2005, the Government Accountability Office has released a sobering report on the soaring price of textbooks. Over the past two decades, the report tells us, “college textbook prices have risen at double the rate of inflation.” We are used to paying $25 for a hardcover novel, but a casebook on contracts now sells to students for $103, and the best selling general chemistry textbook costs $148. At state universities, textbooks and supplies account for 26 percent of all student fees, including tuition. At junior colleges, they are a walloping 72 percent. The need for a more efficient and less costly way of providing textbooks to students is needed and the current invention provides a means for accomplishing these objectives.

As an alternative to the sale of tangible textbooks, a textbook-free environments exist where school officials believe that electronic materials get students more engaged in learning. A report in the Chicago Sun Times on Aug. 19, 2005, revealed that about two years about 600 school districts nationwide had pilot programs to provide laptops for each student—a figure that has likely doubled since then—quoting Mark Schneiderman, Director of Federal Education Policy for the Software and Information Association in Washington, D.C. As noted in the article, most schools still issue textbooks.

Millions of books are lying dormant in libraries, bookstores, offices, businesses, and in the homes and apartments of individual book owner. The invention herein can make productive temporary use of the vast quantity of dormant books through the rental process disclosed.

According to one embodiment of the present invention for renting books, an independent facilitator can obtain access to student class schedules electronically via a school's website class schedule page or through a student supplied schedule which can be inputted to the interactive website or sent from the student user via email to the facilitator. Since the timing of students having access to needed books for the start of classes is critical to the rental experience, the facilitator may solicit class schedule information directly from teachers and professors who are the ones who adopt textbooks for the classes they teach. A professor's network panel can be created on the website that will allow instructors to post their upcoming schedules for the school term and list the textboks that will be used. The professor's panel may also contain information such as titles, author, availability, book content, books rating, and professor's recommendations. The facilitator will primarily use this information to populate its database and create the scheduling page for student to use to rent textbooks.

The student scheduling interface will be a four step process—the student (user) will select a school term, select a department, select a course number and section, and then check-out. This process can automatically assign the correct text from the information provided by the professor, which now resides in the facilitator's database. The student will verify the desired rental period, shipment method, rental rate, and other terms and conditions (“user terms”) and approve the transaction. Students can then rent a selection of books for an entire school year, a semester or a renter defined period.

The student user may also provide the facilitator with his or her upcoming class schedule via secured password protected “My Class Schedule” page located on the facilitator's website. He or she enters the following information: the course ID, institution, school term, class number, or the book's ISBN or UPC. The user's class schedule information can be accessed by the facilitator and queried against the facilitator's database of available books from independent suppliers and related courses to match the correct book by course to the ones selected for rental. This information can be checked against the instructor's database for accuracy—a tool to further enhance the renter's experience. Standard password protection protect users and suppliers.

The next step will be to match the book needed with an owner in possession of the book. Since courses and class schedules vary from school to school and sometimes within sections of an institution, the facilitator may access book requirements for specific courses and classes either electronically or manually from a search of the school's information portal website. When the correct match is made, a request is sent automatically to the owner of that book. The facilitator makes a request of the owner (possessor) to rent the book and upon acceptance of the supplier terms, the supplier transfers the book directly to the student renter. This correction method will also be available to assure accuracy and support the user experience.

Sale items may include auxiliary books or references. Examples of items, include without limitation, professor's handbooks, workbooks, student notes, maps, guides, dictionaries and hornbooks.

### OBJECTS OF THIS INVENTION

An object of the present invention is to provide quick and accurate means for users in need of a textbook for sale or rental. The facilitator provides a real time online ordering screen with inquiry fields that accept the book ISBN or UPC, author, or title and edition used to search the book inventory database. The rental ordering website may provide online bin lists and hold order lists. User lists of textbooks wanted for rent may be populated from professors, who order books from the school book stores. Bin lists may be generated by wholesaler for current books needed for students. Hold order lists are books that are pre-ordered. The order processing may correct for any changes in orders such as lost and missed shipments or any pre-orders by students.

Another object of the embodiments of the current invention includes providing full and immediate logistics regarding shipping and receiving of user orders using current delivery infrastructures, complete with real time online order delivery confirmation and retrieval information.

Another object is to provide users with online information regarding new and old editions or out of print books for rental.

Another object is to provide individualized book buy back pricing schedules based on demand for the book. Wholesale suppliers must also provide a fair and consistent evaluation process of books as part of the buyback program. For example, books received damaged or deemed unrentable will be returned to the user's at his or her expense or trashed. The users should be able to view the list of books they are renting and calculate a buyback price. A book exchange process may also be included and students should be able to calculate price for the exchanges. An appropriate commercially acceptable book return policy will be used that mirrors the facilitator's book order cancellation or return program.

These together with other objects of the invention, along with the various features of novelty which characterize the invention are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

Still other objects and advantages will be apparent from the disclosure that follows.

### SUMMARY OF THE INVENTION

According to one aspect of the invention, a method for transacting a commercial rental of items by an independent facilitator between one or more independent suppliers and a plurality of independent users comprises the facilitator acquiring information of each supplier who is in possession of at least one of the items; the facilitator establishing supplier terms with each supplier for renting the at least one item for a specific period of time; the facilitator acquiring information from each one of the plurality of users who wants to rent the at least one item; the facilitator establishing user terms with each user for renting the at least one item for the specific period of time; the facilitator transacting the supplier terms for renting the at least one item for the specific period of time with each supplier; the facilitator transacting the user terms for renting the at least one item for the specific period of time with each one of the plurality of users; and the facilitator initiating transfer of the at least one item directly from each supplier to each one of the plurality of users. Preferably, the facilitator tracks delivery of each of the at least one item from each one of the plurality of users directly to one of the supplier that transferred the at least one item and another one of the plurality of users.

According to another aspect of the invention, an apparatus for renting items to a plurality of users from one or more suppliers is taught which comprises: one or more processors; and a memory communicatively coupled to the one or more processors. The memory includes one or more sequences of one or more instructions which, when executed by one or more processors, cause the one or more processors to perform the steps of acquiring information of each one or more suppliers who is in possession of at least one of the items, establishing supplier terms with each supplier for renting the at least one item for a specific period of time, acquiring information from each one of the plurality of users who wants to rent the at least one item, establishing user terms with each user for renting the at least one item for a specific period of time, transacting the supplier terms for renting the at least one item for the specific period of time with each supplier, transacting the user terms for renting the at least one item for the specific period of time with each one of the plurality of users, and initiating transfer of the at least one item directly from each supplier to each one of the plurality of users. Tracking delivery of each of the at least one item from each one of the plurality of users directly to one of the supplier that transferred the at least one item and another one of the plurality of users is also preferred.

According to another embodiment, an apparatus for renting items to a plurality of users from one or more suppliers comprises an item rental mechanism. The item rental mechanism has information of each one or more suppliers who is in possession of at least one of the items and are willing to rent the at least one of the items for a specific period of time under predetermined supplier terms and is configured to perform the functions set forth above.

According to one embodiment, a rental and distribution network for textbooks assigned by one or more designators, through at least one internet compatible server for each one or more designators, to a plurality of users, through at least one device coupled to the internet for each of the plurality of users, from one or more suppliers, through an internet compatible system for each of the one or more suppliers, comprise a computer system having one or more processors and a memory communicatively coupled to the one or more processors is disclosed. The memory includes one or more sequences of one or more instructions which, when executed by one or more processors, causes the one or more processors to perform the steps of acquiring information from the at least one internet compatible server for each one or more designators identifying at least one textbook required to be used by a student attending a particular class; acquiring information from the internet compatible system of each one or more suppliers who is in possession of the at least one textbook; acquiring information from the at least one device of each one of the plurality of users who wants to rent the at least one textbook; and initiating transfer of the at least one textbook directly from each supplier to each one of the plurality of users who wants to rent the at least one textbook.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWING

Embodiments of the invention are illustrated by way of example, and not by way of limitation, in the figures of the accompanying drawings and in which like reference numerals refer to similar elements and in which:

FIG. 1 is a diagram depicting an approach for renting items to users showing an independent facilitator and an independent supplier, wherein the facilitator preferably communicates with each of the user and supplier electronically and the supplier transfers and receives the item with the user according to an embodiment of the present invention;

FIG. 2 is a diagram depicting an approach for renting items identified by a designator to a facilitator who facilitates the transfer of an item from a supplier to a user;

FIG. 3 is a flow diagram depicting an approach for renting designated items through a facilitator from a supplier to a user;

FIG. 4 is a flow diagram depicting an approach for renting items through a facilitator from one or more of the suppliers in possession of an identified item including a subsequent disposition of the item at the end of the rental term;

FIG. 5 is a flow diagram depicting an approach for renting items through a facilitator including a method for evaluating suppliers;

FIG. 6 is a flow diagram depicting an approach for renting items through a facilitator including a method for evaluating users; and

FIG. 7 is a block diagram on which embodiments of the invention may be implemented.

### DETAILED DESCRIPTION OF THE INVENTION

In the following description, specific details are set forth in order to provide a thorough understanding of the invention. However, it will be apparent that the invention may be practiced without these specific details. In other instances, structures and devices known in the art are depicted in block diagram form in order to avoid unnecessarily obscuring the invention. Without departing from the generality of the invention disclosed herein and without limiting the scope of the invention, the discussion that follows, will refer to the invention as depicted in the drawing.

According to one embodiment, a method for transacting a commercial rental of items by an independent facilitator 1 between one or more independent suppliers 3 and a plurality of independent users 2 comprises the facilitator acquiring information of each supplier who is in possession of at least one of the items; the facilitator establishing supplier terms with each supplier 3 for renting the at least one item 4 for a specific period of time; the facilitator acquiring information from each one of the plurality of users who wants to rent the at least one item; the facilitator establishing user terms with each user 2 for renting the at least one item for the specific period of time; the facilitator transacting the supplier terms for renting the at least one item for the specific period of time with each supplier; the facilitator transacting the user terms for renting the at least one item for the specific period of time with each one of the plurality of users; the facilitator initiating transfer of the at least one item directly from each supplier to each one of the plurality of users; and the facilitator tracking delivery of each of the at least one item from each one of the plurality of users directly to one of the supplier that transferred the at least one item and another one of the plurality of users. For example and without limitation, the period of time for the rental may be a semester, a quarter, an entire school year or specific dates suggested by the user 2 and acceptable to the facilitator 1. Both transfer and delivery of items may be tracked using bar codes. In an effort to facilitate the transfer and delivery of items between parties, the facilitator may use communication means including but not limited to letters, e-mails, other modes of communication to remind parties of their transfer and delivery obligations with respect to an item.

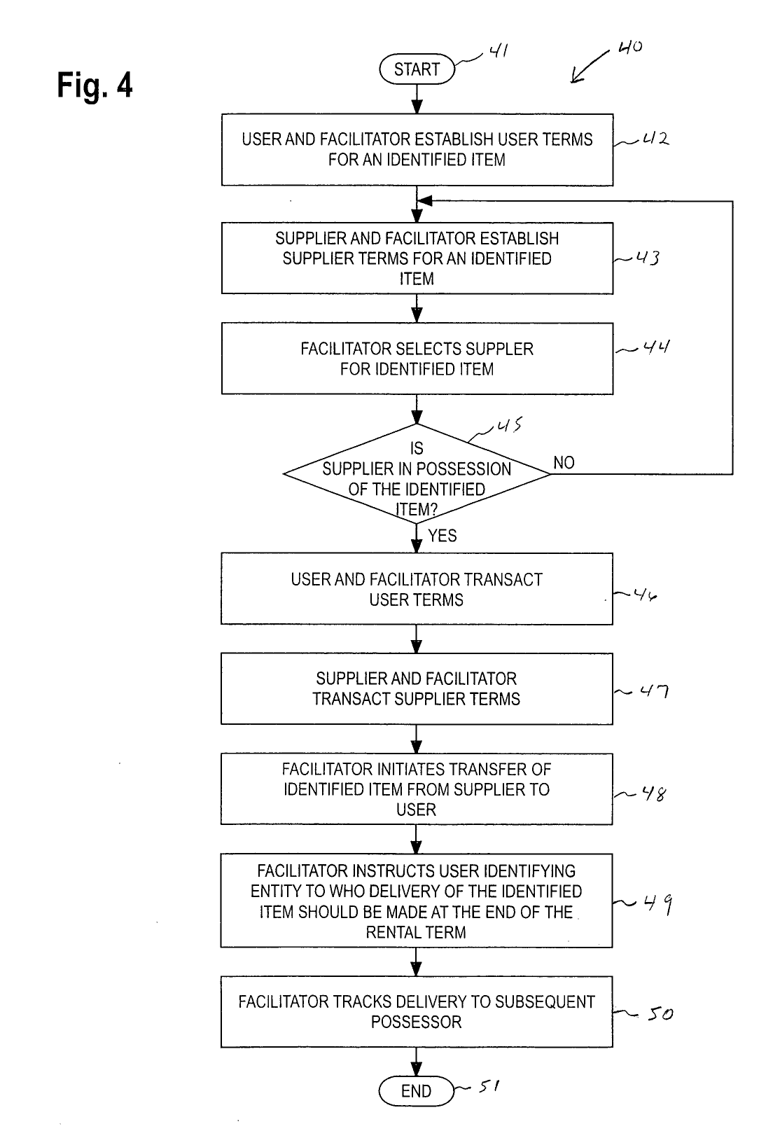

FIG. 4 is a flow diagram 40 illustrating one embodiment of the invention for renting an item to a user from one of a plurality of suppliers 3 and then handling the disposition of the item at the conclusion of the rental. Starting with step 41, a user and the facilitator 1 establishes user rental terms 42 for an item 4; in step 43, one or more suppliers establish supplier terms with the facilitator for the rental of an item; and in step 44, the facilitator will select a supplier for the identified item, which could be based on proximity of the supplier to the user or rating preferences of the user. Next step 45, the facilitator determines whether the selected supplier is in possession of the identified item. If the selected supplier is in possession of the identified item user terms and supplier terms are transacted, steps 46 and 47, and the facilitator initiates transfer of the identified item from supplier to user 48. If the selected supplier is not in possession of the identified item, the process returns to step 43 and another supplier is selected. Near the conclusion of the rental, in step 49, the facilitator instructs user 2 identifying an entity to whom delivery of the identified item should be made, and in step 50, the facilitator tracks delivery to subsequent possessor to end the process 51.

Supplier terms may be different for different suppliers 3 and the invention is not limited to any particular supplier terms for all suppliers. Examples of differences that may affect supplier terms include, without limitation, the quantity and conditions of items supplied, the proximity of a supplier 3 to a user or designator, the transaction rating or rating factor assigned to the supplier. The supplier terms may include the supplier bearing the cost of a standard cost of shipping as part of its costs of doing business. User selected upgraded methods of shipment, where the cost exceeds the $2.40 current charge for USPS standard mail delivery, including express or overnight shipments, would be chargeable to the user as part of the user terms. The supplier terms may be manifested in a supplier agreement or through any other commercially acceptable business practice. Matching parties to a rental transaction will be more economically achieved when the goods and parties are in close proximity to each to reduce shipping costs. Parties, prior to completion of the transaction will also be encouraged to rate their respective experiences.

The facilitator's database may be programmed with an algorithm to generate a survey of questions, for example and without limitation, it will ask whether the item was returned by an expected date and whether its condition remained unchanged, was subject to ordinary wear and tear, or was substantially damaged. A rating system will be established to award points for positive responses and deduct points for negative responses. Each user 2 to the transaction may be rated with a best user rating, a good user rating, a provisionary status rating or unsatisfactory rating which will result in the user having its future transactions denied. Serious disputes may be routed for alternative dispute resolution and not limited to mediation and/or arbitration. The rating process may be used internally exclusively, or in the case of commercial suppliers 3, the process may be more transparent so that the individual users 2 will have an opportunity to gauge from whom their items will be supplied. Other rating factors may be taken into account as experience with the utilization of the invention warrants. To secure the satisfactory performance by a user, a monetary deposit may be required as part of the user terms.

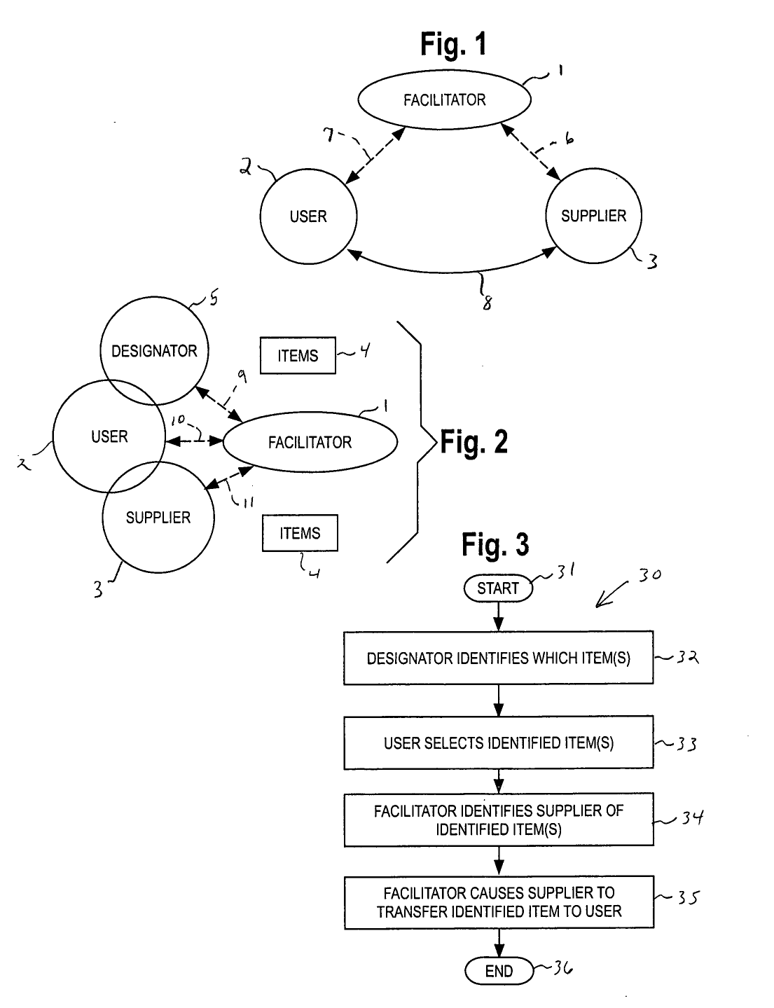

FIG. 1 is a block diagram that illustrates an approach for renting items 4 to users 2 according to various embodiments described herein. As used herein, the term “items” refers to any commercial goods that can be rented to users. Examples of items include professor's handbooks, workbooks, student notes, maps, guides, dictionaries and hornbooks, books stored on a non-volatile memory such as a tape, other magnetic medium, optical medium, read-only memory or the like, including digital books, and the invention is not limited to any particular type of item.

FIG. 2 is a diagram that depicts one of a plurality of users 2 that desires to rent items from a supplier 3 through a facilitator 1. Users 2 communicate with the facilitator 1 over internet links 10, designators 5 communicate with the facilitator 1 over internet links 9, and suppliers 3 communicate with the facilitator 1 over internet links 11. Links 9, 10 and 11 may be any medium for transferring data between the facilitator 1 and the users 2, suppliers 3 and designators, respectively, and the invention is not limited to any particular medium. In the present example, links 9, 10 and 11 may be connections provided by one or more Internet Service Providers (ISPs) and users 2 are configured with generic Internet web browsers. Links 9, 10 and 11 may be secure or unsecured depending upon the requirements of a particular application. In accordance with an embodiment, users 2 enter into a rental agreement with facilitator 1 to rent items 4 from supplier 3 according to the approaches described herein. The invention is not limited to any particular approach for entering into the rental agreement. For example, users 2 and facilitator 1 may enter into a rental agreement by mail, telephone or over the Internet, by users 2 logging into a website associated with the facilitator or by engaging a strategically located automated machine having an item rental mechanism. Users 2 create and provide item selection criteria to facilitator 1 over link 10. The invention is not limited to any particular approach for specifying and providing item selection criteria to facilitator 1. For example, according to one embodiment, users 2 provide item selection criteria to facilitator 1 in one or more data files. According to another embodiment, users 2 log onto a website of facilitator 1 and use a graphical user interfaced (GUI) to specify attributes of the item that users desire to rent through facilitator 1.

The facilitator 1 will maintain in the database acquired information and transactions terms. The facilitator 1 will generally not be purchasing items from anybody and may not be carrying any inventory. Additionally, the database may contain attributes of the items such as shipping weight which will aid in the transfer and delivery of the item.

The user terms may vary for different users and the invention is not limited to any particular user terms for all users. Examples of differences that may affect user terms include, without limitation, the quantity and conditions of items rented, the proximity of a user 2 to a supplier 3 or designator, the transaction rating or rating factor assigned to the user. The user terms may be manifested in a user agreement or through any other commercially acceptable business practice.

The approach just described for renting items to users is now described with reference to a flow diagram of FIG. 3. After starting in step 31, in step 32, the designator 5, which for textbook items will generally be a school, identifies an item 4 creating item selection criteria. In step 33, a student user 2 provides reference data, such as the course ID, institution, school term, class number, or the book's ISBN or UPC to the facilitator to select which item selection criteria applies to the user. In step 34, in response to facilitator 1 receiving the item selection criteria from user 2, facilitator 1 identifies a supplier 3 having an item meeting the user's the item selection criteria. In step 35, the facilitator causes the supplier to transfer the item meeting the user's the item selection criteria to the user. The process is complete in step 36.

Agreements for supplier and users 2 preferably include an identification of the item or items, date of transfer and date of delivery (retransfer or return), and payment amount. An item 4 is preferably a physical object, but the invention is not limited to any particular type of item.

The method for transacting a commercial rental may further comprise the step of the facilitator 1 communicating instructions to each one of the plurality of users 2 identifying one of the supplier and another one of the plurality of users to whom delivery should be made. Additionally, the method for transacting a commercial rental may further comprise the steps of the facilitator determining a rating factor for each supplier 3 based on at least one of the information from the one of the plurality of users and the information of the supplier regarding the date of transfer of the item to the one of the plurality of users.

So that students possessing books can participate in the rental process at least one of the one or more suppliers 3 may include one of the plurality of users. Thus, a user 2 may rent another's book through the facilitator and also rent one of the user's own books to another user. In such application, the another one of the plurality of users 2 may be in possession of a second item for rental, and the method for transacting a commercial rental may further comprise the steps of:
a. the facilitator establishing supplier terms with the another one of the plurality of users for renting the second item for a second specific period of time;
b. the facilitator acquiring information from some other of the plurality of users who want to rent the second item;
c. the facilitator establishing user terms with the some other of the plurality of users for renting the second item for the second specific period of time;
d. the facilitator transacting the supplier terms for renting the second item for the second specific period of time with the another one of the plurality of users;
e. the facilitator transacting the user terms for renting the second item for the second specific period of time with the some other of the plurality of users;
f. the facilitator initiating transfer of the second item directly from the another one of the plurality of users to the some other of the plurality of users; and
g. the facilitator tracking delivery of the second item from the some other of the plurality of users directly to one of the another one of the plurality of users and a different one of the plurality of users.

Moreover, the method may further comprise the step of the facilitator communicating instructions to the some other of the plurality of users 2 identifying one of the different one of the plurality of users and the another of the plurality of users to whom delivery should be made.

According to one embodiment, the method for transacting a commercial rental may further comprise the steps of the facilitator 1 acquiring information from each supplier 3 regarding the condition of the item 4 prior to transfer; the facilitator acquiring information from each one of the plurality of users regarding the condition of the item upon transfer; and the facilitator determining a rating for each supplier 3 based on at least one of the information from the supplier that transferred the item 4 to the one of the plurality of users and from the one of the plurality of users regarding the condition of the item upon transfer.

According to one embodiment, the method for transacting a commercial rental may further comprise the steps of the facilitator 1 determining a rating factor for each supplier based on at least one of the information from the one of the plurality of users and the information of the supplier 3 regarding the date of transfer of the item 4 to the one of the plurality of users. Additionally, at least one of the rating and the rating factor may be assigned a numerical value, and the method may further comprise the steps of the facilitator determining whether the numerical value of the at least one of the rating and the rating factor varies by the predetermined amount from the numerical threshold, and the facilitator restricting the transacting a commercial rental of each supplier 3 when the numerical value of the at least one of the rating and the rating factor varies from the numerical threshold by a predetermined amount.

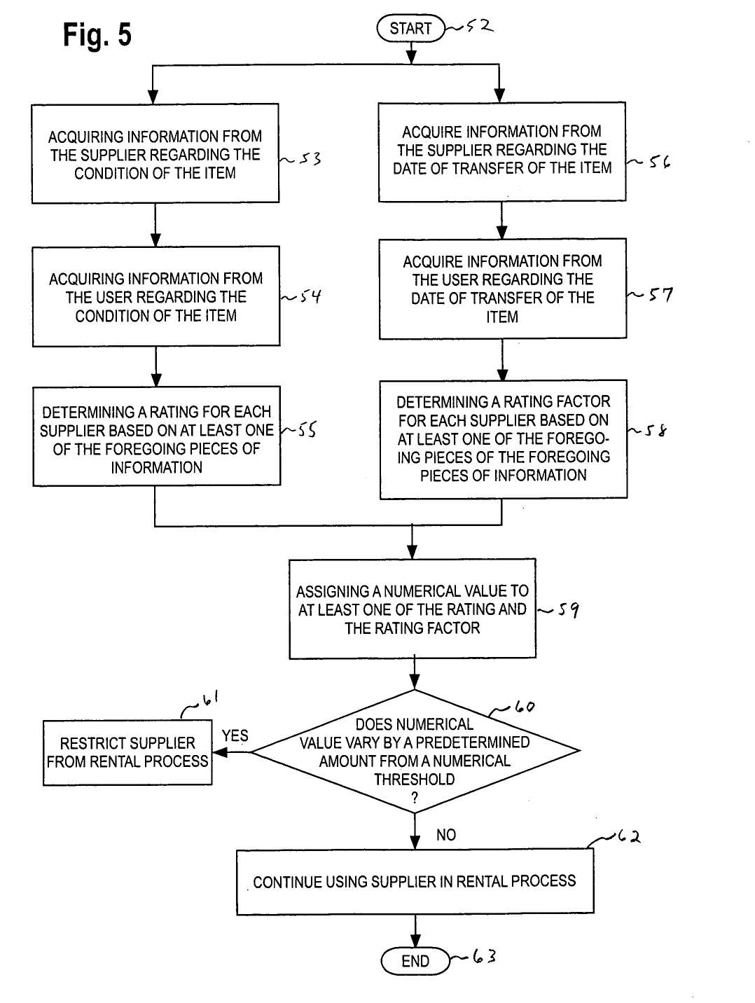

FIG. 5 is a flow diagram illustrating the steps for renting items including methods for evaluating suppliers. Starting with step 52, information is acquired from the supplier regarding the date of transfer 56 of the item and the condition of the item 53, information is acquired from the user regarding the date of transfer 57 of the item and the condition of the item 54, a rating for each supplier is determined based on at least one of the condition of the item from the user and the condition of the item from the supplier 55, and a rating factor for each supplier is determined based on at least one of the date of transfer reported by the supplier and the date of transfer reported by the supplier 58, a numerical value is assigned to at least one of the rating and the rating factor 59, and determining whether the numerical value varies by a predetermined amount from a numerical threshold 60. If the numerical value varies by a predetermined amount from a numerical threshold, then the supplier is restricted from the rental process 61. If the numerical value does not vary by a predetermined amount from a numerical threshold, then the supplier continues to participate in the rental process 62 and this segment of the process concludes.

According to one embodiment, the method for transacting a commercial rental may further comprise the steps of the facilitator acquiring information from one of the plurality of users regarding the condition of the item 4 upon transfer, the facilitator acquiring information from one of the supplier and the another of the plurality of users regarding the condition of the item upon delivery, and the facilitator determining a rating for each one of the plurality of users based on at least one of the information from the one of the plurality of users 2 and the information from the supplier 3 or the another one of the plurality of users to whom the item was delivered regarding the condition of the item upon delivery.

Moreover, the method for transacting a commercial rental may further comprise the step of the facilitator determining a rating factor for each one of the plurality of users based on at least one of the information from the one of the plurality of users and the information from the supplier 3 or the another one of the plurality of users to whom the item 4 was delivered regarding the date of delivery. Additionally, at least one of the rating and the rating factor may be assigned a numerical value, and the method may further comprise the steps of the facilitator determining whether the numerical value of the at least one of the rating and the rating varies by the predetermined amount from the numerical threshold and the facilitator restricting the transacting a commercial rental of each one of the plurality of users when the numerical value of the at least one of the rating and the rating factor varies by the predetermined amount from the numerical threshold.

According to one embodiment, the method for transacting a commercial rental may further comprise the steps of the facilitator acquiring information from a possessor of one of the items regarding the condition of the item 4 upon transfer, the facilitator acquiring information from a successor to the possessor regarding the condition of the item upon delivery, and the facilitator determining a rating for the possessor based on at least one of the information from the possessor and the information from the successor to the possessor regarding the condition of the item upon delivery.

Moreover, the method for transacting a commercial rental may further comprise the step of the facilitator determining a rating factor for each possessor based on at least one of the information from the possessor and the information from the successor to the possessor regarding the date of delivery.

Additionally, at least one of the rating and the rating factor may be assigned a numerical value, and the method may further comprise the steps of the facilitator determining whether the numerical value of the at least one of the rating and the rating factor varies by a predetermined amount from the numerical threshold, and the facilitator restricting the transacting a commercial rental of each based on at least one of the information from the possessor (supplier 3) and the information from the successor to the possessor when the numerical value of the at least one of the rating and the rating factor varies by the predetermined amount from the numerical threshold.

In situations where the item 4 is passed on from one renter (user 2) to another (the another of the plurality of users), the method may further comprise the step of the another of the plurality of users 2 assessing the condition of the item upon delivery and rating the condition.

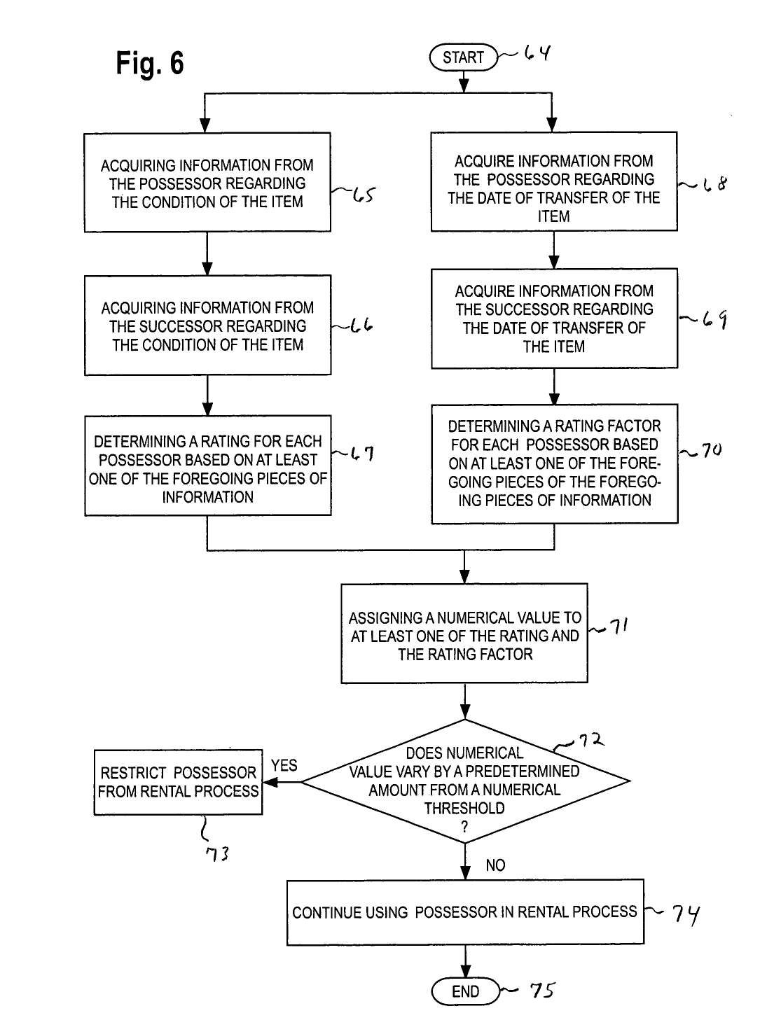

FIG. 6 is a flow diagram depicting an approach for renting items including a method for evaluating users. Starting with step 64, acquiring information from a possessor regarding the date of transfer 68 and the condition of the item 65, acquiring information from a successor regarding the date of transfer of the item 69 and the condition of the item 66, determining a rating factor for each possessor based on at least one of the date of transfer form the possessor and the date of transfer from the successor 70, and determining a rating for each possessor based on at least one of the condition from the possessor and the condition from the successor 67, assigning a numerical value to at least one of the rating and the rating factor 71, and determining whether the numerical value varies by a predetermined amount from a numerical threshold 72. If the numerical value varies by a predetermined amount from a numerical threshold, then the possessor is restricted from the rental process 73. If the numerical value does not vary by a predetermined amount from a numerical threshold, then the possessor continues to participate in the rental process 74 and this segment of the process concludes.

One of the important preferred aspects of the present invention is that the facilitator 1 maintains no inventory. Thus, the transfer of the at least one item 4 directly from each supplier 3 to each one of the plurality of users 2 may be independent of the facilitator maintaining a physical inventory of the item. Additionally, the delivery of the at least one item directly from one of the plurality of users to another of the plurality of users may also be independent of the facilitator maintaining a physical inventory of the item.

It should be clear that the facilitator 1 is independent of the plurality of users. Moreover, the facilitator is independent of the one or more suppliers 3. Additionally, the transfer of the at least one item 4 directly from each supplier to each one of the plurality of users is independent of an ongoing subscription between the facilitator and either of the at least one of the plurality of users or the one or more suppliers 3.

In one embodiment, the items comprise books that are assigned by one or more designators, and each one or more suppliers 3 is one of a book publisher, a book distributor, a book retailer, a library, a business and an individual book owner; and furthermore, the method comprises the step of the facilitator acquiring information from the one or more designators 5 regarding the books that are assigned. Moreover, the books may comprise textbooks and each of the one or more designators may be one of a school, a teacher and one of the plurality of users. Additionally, the method may further comprise the step of the facilitator acquiring information identifying the textbooks directly from the designator. The item 4 may be identified by a wide range of criteria. The invention is not limited to any particular criteria. Samples of identifying criteria include without limitation, title, the author, the edition, the ISBN or the UPC identifier. Additionally, the course ID, the school term and class, and the ISBN number may also be provided.

According to one embodiment of a method for renting items to a plurality of users 2 from one or more suppliers 3, the method comprises computer implemented steps of acquiring information of each one or more suppliers who is in possession of at least one of the items, establishing supplier terms with each supplier for renting the at least one item for a specific period of time, acquiring information from each one of the plurality of users who wants to rent the at least one item, establishing user terms with each user for renting the at least one item for a specific period of time, transacting the supplier terms for renting the at least one item for the specific period of time with each supplier, transacting the user terms for renting the at least one item for the specific period of time with each one of the plurality of users, and i)initiating transfer of the at least one item 4 directly from each supplier 3 to each one of the plurality of users.

The method may further comprise computer implemented step of tracking delivery of each of the at least one item from each one of the plurality of users directly to one of the supplier that transferred the at least one item and another one of the plurality of users. Moreover, the user terms may include an option for each user to purchase the at least one item 4 and may further comprise the steps of transacting the user terms for selling the at least one item with each one of the plurality of users 2 that elected to purchase the at least one item in lieu of transacting the user terms for renting the at least one item for the specific period of time with each one of the plurality of users that elected to purchase the at least one item.

Preferably, the method further comprises computer implemented steps of communicating instructions to each one of the plurality of users identifying one of the supplier and another one of the plurality of users to whom delivery should be made. As noted earlier, at least one of the one or more suppliers may also be one of the plurality of users and the another one of the plurality of users may be in possession of a second item for rental, and the method may further comprise computer implemented steps of:
a. establishing supplier terms with the another one of the plurality of users for renting the second item for a second specific period of time;
b. acquiring information from some other of the plurality of users who want to rent the second item;
c. establishing user terms with the some other of the plurality of users for renting the second item for the second specific period of time;
d. transacting the supplier terms for renting the second item for the second specific period of time with the another one of the plurality of users;
e. transacting the user terms for renting the second item for the second specific period of time with the some other of the plurality of users;
f. initiating transfer of the second item directly from the another one of the plurality of users to the some other of the plurality of users; and
g. tracking delivery of the second item from the some other of the plurality of users directly to one of the another one of the plurality of users and a different one of the plurality of users.

According to one embodiment, the method for renting items to a plurality of users may further comprise the computer implemented step of communicating instructions to the some other of the plurality of users identifying one of the different one of the plurality of users and the another of the plurality of users to whom delivery should be made.

According to one embodiment, the method for renting items to a plurality of users 2 may further comprise the computer implemented steps of:
a. acquiring information from each supplier regarding the condition of the item 4 prior to transfer;
b. acquiring information from each one of the plurality of users regarding the condition of the item upon transfer; and
c. determining a rating for a transaction involving each supplier based on at least one of the information from the supplier that transferred the item to the one of the plurality of users and the one of the plurality of users regarding the condition of the item upon transfer.

The method for renting items to a plurality of users 2 may further comprise the computer implemented step of determining a rating factor for a transaction involving each supplier 3 based on at least one of the information from the one of the plurality of users and the information of the supplier regarding the date of transfer of the item 4 to the one of the plurality of users. Preferably, the method for renting items to a plurality of users comprises the computer implemented step of determining a rating factor for a transaction involving each supplier based on at least one of the information from the one of the plurality of users and the information of the supplier regarding the date of transfer of the item to the one of the plurality of users.

According to one embodiment of the method for renting items to a plurality of users, at least one of the rating and the rating factor for the transaction is assigned a numerical value, and further comprise the computer implemented steps of determining whether a numerical value of the at least one of the rating and the rating factor for the transactions of each supplier 3 varies by a predetermined amount from a numerical threshold, and restricting the transacting of a commercial rental of each supplier when the numerical value of each supplier varies by the predetermined amount from the numerical threshold.

In order to evaluate whether any not normal damage has been caused to the rental item, the method may further comprise the computer implemented steps of:
a. acquiring information from one of the plurality of users regarding the condition of the item upon transfer;
b. acquiring information from one of the supplier and the another of the plurality of users regarding the condition of the item upon delivery; and
c. determining a rating for each one of the plurality of users based on at least one of the information from the one of the plurality of users and the information from the supplier or the another one of the plurality of users to whom the item was delivered regarding the condition of the item upon delivery.
   Moreover, the method may further comprise the computer implemented step of determining a rating factor for each one of the plurality of users based on at least one of the information from the one of the plurality of users and the information from the supplier or the another one of the plurality of users to whom the item was delivered regarding the date of delivery. Therefore, at least one of the rating and the rating factor for the transaction may be assigned a numerical value, and the method may further comprise the computer implemented steps of determining whether a numerical value of the at least one of the rating and the rating factor for the transactions of each supplier varies by a predetermined amount from a numerical threshold, and restricting the transacting a commercial rental of each supplier when the numerical value of each supplier varies by the predetermined amount from the numerical threshold.

Preferably, the computer implemented steps of the method include acquiring information from a possessor of one of the items regarding the condition of the item 4 upon transfer, acquiring information from a successor to the possessor regarding the condition of the item upon delivery, and determining a rating for the possessor based on at least one of the information from the possessor and the information from the successor to the possessor regarding the condition of the item upon delivery. Moreover, the method may further comprise the computer implemented step of determining a rating factor for each possessor based on at least one of the information from the possessor and the information from the successor to the possessor regarding the date of delivery. Additionally, at least one of the rating and the rating factor for the transaction may be assigned a numerical value, and the method may further comprise the computer implemented steps of determining whether a numerical value of the at least one of the rating and the rating factor for the transactions of each supplier varies by a predetermined amount from a numerical threshold, and restricting the transacting a commercial rental of each supplier when the numerical value of each supplier varies by the predetermined amount from the numerical threshold.

In one embodiment of the method for renting items to a plurality of users, the computer implemented step of the another of the plurality of users 2 assessing the condition of the item upon delivery and rating the condition is provided.

Preferably, the transfer of the at least one item 4 directly from each supplier 3 to each one of the plurality of users 2 is independent of maintaining a physical inventory of the at least one item. Additionally, the transfer of the at least one item directly from each supplier to each one of the plurality of users may be independent of an ongoing subscription with the plurality of users.

According to one embodiment of the computer implemented method for renting items to a plurality of users 2 in which the items comprise books that are assigned by one or more designators, and each one or more suppliers 3 is one of a book publisher, a book distributor, a book retailer, a library, a business and an individual book owner, the further step of acquiring information from the one or more designators regarding the books that are assigned is provided. Moreover, the books may comprise textbooks and each of the one or more designators 5 may be one of a school, a teacher and one of the plurality of users. Additionally, the method for renting items to a plurality of users may further comprise the computer implemented step of acquiring information identifying the textbooks directly from the designator.

According to one embodiment, a computer-readable medium for renting items to a plurality of users 2 from one or more suppliers 3, the computer-readable medium carrying one or more sequences of one or more instructions which, when executed by one or more processors, cause the one or more processors to perform the computer-implemented steps of:
a. acquiring information of each one or more suppliers who is in possession of at least one of the items;
b. establishing supplier terms with each supplier for renting the at least one item for a specific period of time;
c. acquiring information from each one of the plurality of users who wants to rent the at least one item;
d. establishing user terms with each user for renting the at least one item for a specific period of time;
e. transacting the supplier terms for renting the at least one item for the specific period of time with each supplier;
f. transacting the user terms for renting the at least one item for the specific period of time with each one of the plurality of users;
g. initiating transfer of the at least one item directly from each supplier to each one of the plurality of users; and
h. tracking delivery of each of the at least one item from each one of the plurality of users directly to one of the supplier that transferred the at least one item and another one of the plurality of users.

The computer-readable medium for renting items to a plurality of users may further comprise one or more sequences of one or more instructions which, when executed by the one or more processors, cause the one or more processors to perform the step of communicating instructions to each one of the plurality of users identifying one of the supplier 3 and another one of the plurality of users to whom delivery should be made. Furthermore, at least one of the one or more suppliers 3 may be one of the plurality of users 2.

In one embodiment in which the another one of the plurality of users is in possession of a second item for rental, the computer-readable medium may further comprise one or more sequences of one or more instructions which, when executed by the one or more processors, cause the one or more processors to perform the step of:
a. establishing supplier terms with the another one of the plurality of users for renting the second item for a second specific period of time;
b. acquiring information from some other of the plurality of users who want to rent the second item;
c. establishing user terms with the some other of the plurality of users for renting the second item for the second specific period of time;
d. transacting the supplier terms for renting the second item for the second specific period of time with the another one of the plurality of users;
e. transacting the user terms for renting the second item for the second specific period of time with the some other of the plurality of users;
f. initiating transfer of the second item directly from the another one of the plurality of users to the some other of the plurality of users; and
g. tracking delivery of the second item from the some other of the plurality of users directly to one of the another one of the plurality of users and a different one of the plurality of users.

According to one embodiment, the computer-readable medium may further comprise one or more sequences of one or more instructions which, when executed by the one or more processors, cause the one or more processors to perform the step of communicating instructions to the some other of the plurality of users identifying one of the different one of the plurality of users and the another of the plurality of users to whom delivery should be made.

Moreover, the computer-readable medium for renting items to a plurality of users may further comprise one or more sequences of one or more instructions which, when executed by the one or more processors, cause the one or more processors to perform the steps of:
a. acquiring information from each supplier regarding the condition of the item prior to transfer;
b. acquiring information from each one of the plurality of users regarding the condition of the item upon transfer; and
c. determining a rating for each supplier based on at least one of the information from the supplier that transferred the item to the one of the plurality of users and the one of the plurality of users regarding the condition of the item upon transfer.

Preferably, the computer-readable medium comprises one or more sequences of one or more instructions which, when executed by the one or more processors, cause the one or more processors to perform the step of determining a rating factor for each supplier 3 based on at least one of the information from the one of the plurality of users and the information of the supplier regarding the date of transfer of the item to the one of the plurality of users.

In addition, the computer-readable medium in which at least one of the rating and the rating factor for the transaction is assigned a numerical value, may further comprise one or more sequences of one or more instructions which, when executed by the one or more processors, cause the one or more processors to perform the steps of: determining whether a numerical value of the at least one of the rating and the rating factor for the transactions of each supplier 3 varies by a predetermined amount from a numerical threshold, and restricting the transacting of a commercial rental of each supplier when the numerical value of each supplier varies by the predetermined amount from the numerical threshold.

Furthermore, according to one preferred aspect of the computer-readable medium for renting items to a plurality of users, one or more sequences of one or more instructions which, when executed by the one or more processors, cause the one or more processors to perform the steps of acquiring information from one of the plurality of users 2 regarding the condition of the item 4 upon transfer, acquiring information from one of the supplier 3 and the another of the plurality of users regarding the condition of the item 4 upon delivery, and determining a rating for each one of the plurality of users based on at least one of the information from the one of the plurality of users and the information from the supplier or the another one of the plurality of users to whom the item 4 was delivered regarding the condition of the item upon delivery. Moreover, it may also determine a rating factor for each one of the plurality of users based on at least one of the information from the one of the plurality of users and the information from the supplier or the another one of the plurality of users to whom the item was delivered regarding the date of delivery. Thus, at least one of the rating and the rating factor for the transaction may be assigned a numerical value, and the computer-readable medium may further comprise one or more sequences of one or more instructions which, when executed by the one or more processors, cause the one or more processors to perform the steps of determining whether a numerical value of the at least one of the rating and the rating factor for the transactions of each supplier varies by a predetermined amount from a numerical threshold, and restricting the transacting of a commercial rental of each supplier when the numerical value of each supplier varies by the predetermined amount from the numerical threshold.

In one embodiment of the computer-readable medium for renting items to a plurality of users, one or more sequences of one or more instructions which, when executed by the one or more processors, may further cause the one or more processors to perform the steps of:
a. acquiring information from a possessor of one of the items regarding the condition of the item upon transfer;
b. acquiring information from a successor to the possessor regarding the condition of the item upon delivery; and
c. determining a rating for the possessor based on at least one of the information from the possessor and the information from the successor to the possessor regarding the condition of the item upon delivery.
   Moreover, the step of determining a rating factor for each possessor based on at least one of the information from the possessor and the information from the successor to the possessor regarding the date of delivery may be caused by the one or more processors. Additionally, the computer-readable medium for renting items to a plurality of users 2 may have at least one of the rating and the rating factor for the transaction is assigned a numerical value and may further comprise one or more sequences of one or more instructions which, when executed by the one or more processors, cause the one or more processors to perform the steps of determining whether a numerical value of the at least one of the rating and the rating factor for the transactions of each supplier varies by a predetermined amount from a numerical threshold, and restricting the transacting of a commercial rental of each supplier based on at least one of the information from the possessor and the information from the successor to the possessor when the numerical value of each supplier varies by the predetermined amount from the numerical threshold.

In one embodiment the computer-readable medium for renting items to a plurality of users may further comprise one or more sequences of one or more instructions which, when executed by the one or more processors, cause the one or more processors to perform the step of the another of the plurality of users assessing the condition of the item upon delivery and rating the condition.

According to one embodiment, the transfer of the at least one item 4 directly from each supplier 3 to each one of the plurality of users is independent of maintaining a physical inventory of the item. Moreover, the transfer of the at least one item directly from each supplier to each one of the plurality of users 2 may be independent of an ongoing subscription with the plurality of users.

According to another embodiment, the computer-readable medium for renting items to a plurality of users, the items may comprise books that are assigned by one or more designators, and each one or more suppliers 3 may be one of a book publisher, a book distributor, a book retailer, a library, a business and an individual book owner. Furthermore, the computer-readable medium may comprise one or more sequences of one or more instructions which, when executed by the one or more processors, cause the one or more processors to perform the step of acquiring information from the one or more designators 5 regarding the books that are assigned. Moreover, the books preferably comprise textbooks and each of the one or more designators 5 is one of a school, a teacher and one of the plurality of users. Additionally, the computer-readable medium may further comprise one or more sequences of one or more instructions which, when executed by the one or more processors, cause the one or more processors to perform the step of acquiring information identifying the textbooks directly from the designator.

In one embodiment of the invention, an apparatus for renting items to a plurality of users 2 from one or more suppliers 3 is taught which comprises:
a. one or more processors; and
b. a memory communicatively coupled to the one or more processors, the memory including one or more sequences of one or more instructions which, when executed by one or more processors, cause the one or more processors to perform the steps of:
   i. acquiring information of each one or more suppliers who is in possession of at least one of the items,
   ii. establishing supplier terms with each supplier for renting the at least one item for a specific period of time,
   iii. acquiring information from each one of the plurality of users who wants to rent the at least one item,
   iv. establishing user terms with each user for renting the at least one item for a specific period of time,
   v. transacting the supplier terms for renting the at least one item for the specific period of time with each supplier,
   vi. transacting the user terms for renting the at least one item for the specific period of time with each one of the plurality of users,
   vii. initiating transfer of the at least one item directly from each supplier to each one of the plurality of users, and
   viii. tracking delivery of each of the at least one item from each one of the plurality of users directly to one of the supplier that transferred the at least one item and another one of the plurality of users.
      Moreover, the memory may further comprise one or more sequences of one or more instructions which, when executed by the one or more processors, cause the one or more processors to perform the step of communicating instructions to each one of the plurality of users identifying one of the supplier and another one of the plurality of users to whom delivery should be made. Furthermore, at least one of the one or more suppliers may be one of the plurality of users.

According to one embodiment, the apparatus for renting items to a plurality of users 2 accommodates a situation in which the another one of the plurality of users is in possession of a second item for rental and the memory further comprises one or more sequences of one or more instructions which, when executed by the one or more processors, cause the one or more processors to perform the step of establishing supplier terms with the another one of the plurality of users for renting the second item for a second specific period of time, acquiring information from some other of the plurality of users who want to rent the second item, establishing user terms with the some other of the plurality of users for renting the second item for the second specific period of time, transacting the supplier terms for renting the second item for the second specific period of time with the another one of the plurality of users, transacting the user terms for renting the second item for the second specific period of time with the some other of the plurality of users, initiating transfer of the second item directly from the another one of the plurality of users to the some other of the plurality of users, and tracking delivery of the second item from the some other of the plurality of users directly to one of the another one of the plurality of users and a different one of the plurality of users.

Preferably, the memory of the apparatus further comprises one or more sequences of one or more instructions which, when executed by the one or more processors, cause the one or more processors to perform the step of communicating instructions to the some other of the plurality of users identifying one of the different one of the plurality of users and the another of the plurality of users to whom delivery should be made.

The memory may further comprise one or more sequences of one or more instructions which, when executed by the one or more processors, cause the one or more processors to perform the steps of acquiring information from each supplier 3 regarding the condition of the item 4 prior to transfer, acquiring information from each one of the plurality of users regarding the condition of the item upon transfer, and determining a rating for each supplier based on at least one of the information from the supplier that transferred the item to the one of the plurality of users and the one of the plurality of users regarding the condition of the item upon transfer. And the memory may further comprise one or more sequences of one or more instructions which, when executed by the one or more processors, cause the one or more processors to perform the step of determining a rating factor for each supplier based on at least one of the information from the one of the plurality of users and the information of the supplier regarding the date of transfer of the item to the one of the plurality of users.

In one embodiment of the apparatus, the memory further comprises one or more sequences of one or more instructions which, when executed by the one or more processors, cause the one or more processors to perform the step of determining a rating factor for each supplier 3 based on at least one of the information from the one of the plurality of users 2 and the information of the supplier regarding the date of transfer of the item to the one of the plurality of users. Additionally, at least one of the rating and the rating factor may be assigned a numerical value and the memory may further comprise one or more sequences of one or more instructions which, when executed by the one or more processors, cause the one or more processors to perform the steps of determining whether a numerical value of the at least one of the rating and the rating factor for the transactions of each supplier varies by a predetermined amount from a numerical threshold, and restricting the transacting of a commercial rental of each supplier when the numerical value of each supplier varies by the predetermined amount from the numerical threshold.

A preferred embodiment of the apparatus includes the memory having one or more sequences of one or more instructions which, when executed by the one or more processors, cause the one or more processors to perform the steps of acquiring information from one of the plurality of users regarding the condition of the item upon transfer, acquiring information from one of the supplier 3 and the another of the plurality of users regarding the condition of the item 4 upon delivery, and determining a rating for each one of the plurality of users based on at least one of the information from the one of the plurality of users and the information from the supplier or the another one of the plurality of users to whom the item was delivered regarding the condition of the item upon delivery.

Moreover, the memory may further comprise one or more sequences of one or more instructions which, when executed by the one or more processors, cause the one or more processors to perform the step of determining a rating factor for each one of the plurality of users based on at least one of the information from the one of the plurality of users and the information from the supplier or the another one of the plurality of users to whom the item 4 was delivered regarding the date of delivery. Additionally, for an apparatus in which at least one of the rating and the rating factor is assigned a numerical value, the memory may further comprises one or more sequences of one or more instructions which, when executed by the one or more processors, cause the one or more processors to perform the steps of determining whether a numerical value of the at least one of the rating and the rating factor for the transactions of each supplier varies by a predetermined amount from a numerical threshold, and restricting the transacting of a commercial rental of each supplier when the numerical value of the supplier varies by the predetermined amount from the numerical threshold.

In one embodiment of the apparatus for renting items to a plurality of users, the memory may further comprise one or more sequences of one or more instructions which, when executed by the one or more processors, cause the one or more processors to perform the steps of:
a. acquiring information from a possessor of one of the items regarding the condition of the item 4 upon transfer;
b. acquiring information from a successor to the possessor regarding the condition of the item upon delivery; and
c. determining a rating for the possessor based on at least one of the information from the possessor and the information from the successor to the possessor regarding the condition of the item upon delivery.
   Moreover, the memory may further comprise one or more sequences of one or more instructions which, when executed by the one or more processors, cause the one or more processors to perform the step of determining a rating factor for each possessor based on at least one of the information from the possessor and the information from the successor to the possessor regarding the date of delivery. Additionally, at least one of the rating and the rating factor may be assigned a numerical value, and the memory may further comprise one or more sequences of one or more instructions which, when executed by the one or more processors, cause the one or more processors to perform the steps of determining whether the numerical value of the at least one of the rating and the rating factor varies by a predetermined amount from the numerical threshold, and restricting the transacting of a commercial rental of each based on at least one of the information from the possessor and the information from the successor to the possessor when the numerical value of the at least one of the rating and the rating factor varies by the predetermined amount from the numerical threshold.

According to one embodiment the apparatus for renting items to a plurality of users 2 has the memory further comprising one or more sequences of one or more instructions which, when executed by the one or more processors, cause the one or more processors to perform the step of the another of the plurality of users assessing the condition of the item 4 upon delivery and rating the condition.

In a preferred embodiment of the apparatus for renting items to a plurality of users, the transfer of the at least one item 4 directly from each supplier 3 to each one of the plurality of users is independent of maintaining a physical inventory of the item. In another embodiment of the apparatus, the transfer of the at least one item directly from each supplier to each one of the plurality of users may be independent of an ongoing subscription with the plurality of users.

Preferably, in the apparatus for renting items to a plurality of users, the items comprise books that are assigned by one or more designators, and each one or more suppliers 3 is one of a book publisher, a book distributor, a book retailer, a library, a business and an individual book owner, and the memory further comprises one or more sequences of one or more instructions which, when executed by the one or more processors, cause the one or more processors to perform the step of acquiring information from the one or more designators 5 regarding the books that are assigned. Moreover, the books may comprise textbooks and each of the one or more designators is one of a school, a teacher and one of the plurality of users. Additionally, the memory may further comprise one or more sequences of one or more instructions which, when executed by the one or more processors, cause the one or more processors to perform the step of acquiring information identifying the textbooks directly from the designator.

According to another embodiment, an apparatus for renting items to a plurality of users 2 from one or more suppliers 3 comprises an item rental mechanism, with information of each one or more suppliers who is in possession of at least one of the items and are willing to rent the at least one of the items for a specific period of time under predetermined supplier terms, configured to:
a. acquire information from each one of the plurality of users who wants to rent the at least one item;
b. communicate user terms with each user for renting the at least one item for the specific period of time;
c. transact the user terms for renting the at least one item for the specific period of time between a facilitator and each one of the plurality of users; and
d. in response to transacting the user terms for renting the at least one item for the specific period of time, transacting the supplier terms for renting the at least one item for the specific period of time with each supplier and initiating transfer of the at least one item directly from each supplier to each one of the plurality of users.
   Moreover, the item rental mechanism may be further configured to track delivery of each of the at least one item from each one of the plurality of users directly to one of the supplier that transferred the at least one item and another one of the plurality of users. Additionally, the item rental mechanism may further configured to communicate instructions to each one of the plurality of users identifying one of the supplier and another one of the plurality of users to whom delivery should be made.

Preferably, the item rental mechanism is further configured to transfer the at least one item directly from each supplier to each one of the plurality of users independent of maintaining a physical inventory of the item. The item rental mechanism may further be configured to transfer the at least one item directly from each supplier to each one of the plurality of users independent of an ongoing subscription with the plurality of users.

According to one embodiment of the invention, a rental and distribution network for textbooks assigned by one or more designators, through at least one internet compatible server for each one or more designators, to a plurality of users, through at least one device coupled to the internet for each of the plurality of users, from one or more suppliers 3, through an internet compatible system for each of the one or more suppliers, comprise a computer system having one or more processors and a memory communicatively coupled to the one or more processors, the memory include one or more sequences of one or more instructions which, when executed by one or more processors, causes the one or more processors to perform the steps of:
a. acquiring information from the at least one internet compatible server for each one or more designators identifying at least one textbook required to be used by a student attending a particular class;
b. acquiring information from the internet compatible system of each one or more suppliers who is in possession of the at least one textbook;
c. acquiring information from the at least one device of each one of the plurality of users who wants to rent the at least one textbook; and
d. initiating transfer of the at least one textbook directly from each supplier to each one of the plurality of users who wants to rent the at least one textbook.

Preferably, the memory further includes one or more sequences of one or more instructions which, when executed by one or more processors, cause the one or more processors to perform the steps of communicating instructions to each one of the plurality of users who rented the at least one textbook regarding delivery to one of the supplier that transferred the who wants to rent the at least one textbook and another one of the plurality of users, and tracking delivery of each of the at least one textbook from each one of the plurality of users directly to one of the supplier that transferred the who wants to rent the at least one textbook and another one of the plurality of users.

In one embodiment of the rental and distribution network for textbooks, at least one of the one or more suppliers is one of the plurality of users. Preferably, the memory further comprises one or more sequences of one or more instructions which, when executed by the one or more processors, cause the one or more processors to perform the steps of establishing supplier terms with each supplier for renting the at least one textbook for a specific period of time, establishing user terms with each user 2 for renting the at least one textbook for a specific period of time, transacting the supplier terms for renting the at least one textbook for the specific period of time with each supplier, and transacting the user terms for renting the at least one textbook for the specific period of time with each one of the plurality of users. Moreover, when the another one of the plurality of users is in possession of a second textbook for rental, the memory may further comprise one or more sequences of one or more instructions which, when executed by the one or more processors, cause the one or more processors to perform the steps of establishing supplier terms with the another one of the plurality of users for renting the second textbook for a second specific period of time, acquiring information from some other of the plurality of users who want to rent the second textbook, initiating transfer of the second textbook directly from the another one of the plurality of users to the some other of the plurality of users, and tracking delivery of the second textbook from the some other of the plurality of users directly to one of the another one of the plurality of users and a different one of the plurality of users.

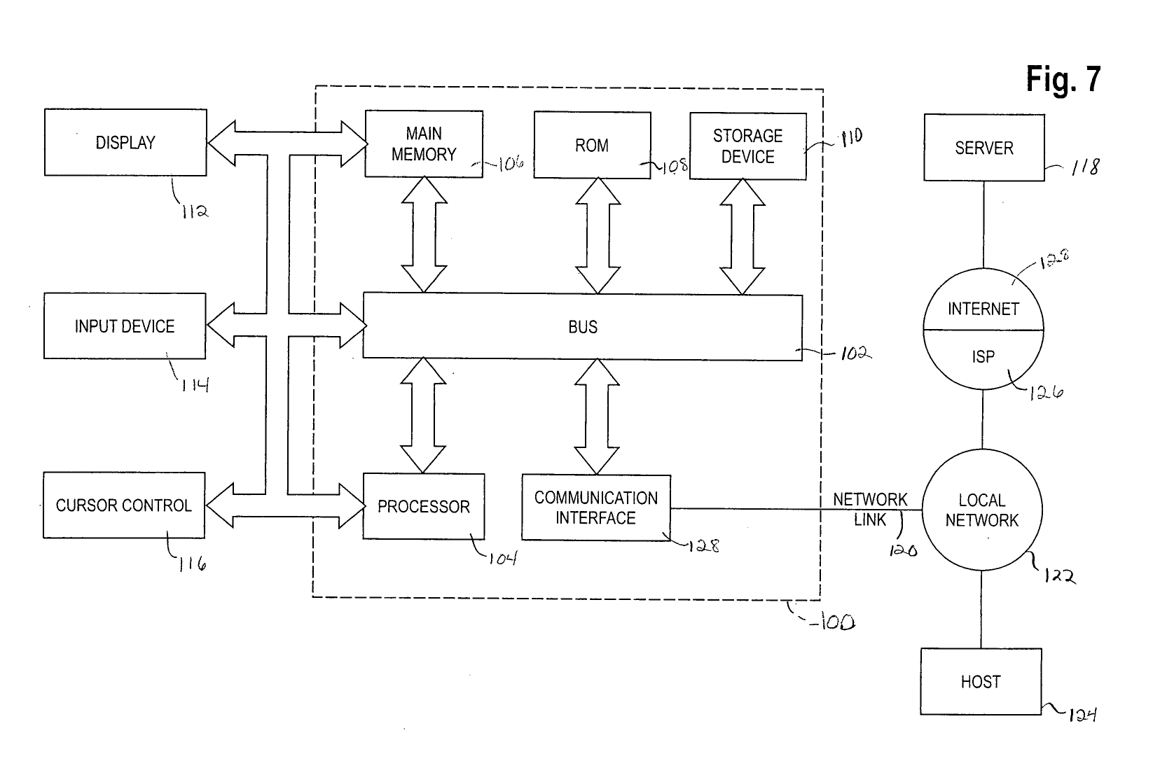

The approach described herein for renting items to users 2 is applicable to any type of rental application and (without limitation) is particularly well suited for Internet-based rental applications for renting movies and music to users. The invention may be implemented in hardware circuitry, in computer software, or a combination of hardware circuitry and computer software and is not limited to a particular hardware or software implementation. FIG. 7 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

The invention is related to the use of computer system 100 for renting items to users. According to one embodiment of the invention, the renting of items to users is provided by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 118 might transmit a requested code for an application program through Internet 128, ISP 126, local network 122 and communication interface 118. In accordance with the invention, one such downloaded application provides for the renting of items to users as described herein.

The received code may be executed by processor 104 as it is received, and/or stored in storage device 110, or other non-volatile storage for later execution. In this manner, computer system 100 may obtain application code in the form of a carrier wave.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

My invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A method for transacting a commercial rental of items by an independent facilitator between one or more independent suppliers and a plurality of independent users comprising:
a. the facilitator acquiring information of each supplier who is in possession of at least one of the items;
b. the facilitator establishing supplier terms with each supplier for renting the at least one item for a specific period of time;
c. the facilitator acquiring information from each one of the plurality of users who wants to rent the at least one item;
d. the facilitator establishing user terms with each user for renting the at least one item for the specific period of time;
e. the facilitator transacting the supplier terms for renting the at least one item for the specific period of time with each supplier;
f. the facilitator transacting the user terms for renting the at least one item for the specific period of time with each one of the plurality of users;
g. the facilitator initiating transfer of the at least one item directly from each supplier to each one of the plurality of users; and
h. the facilitator tracking delivery of each of the at least one item from each one of the plurality of users directly to one of the supplier that transferred the at least one item and another one of the plurality of users.

2. The method for transacting a commercial rental of claim 1, further comprising the step of the facilitator communicating instructions to each one of the plurality of users identifying one of the supplier and another one of the plurality of users to whom delivery should be made.

3. The method for transacting a commercial rental of claim 1, wherein at least one of the one or more suppliers is one of the plurality of users.

4. The method for transacting a commercial rental of claim 1, wherein the another one of the plurality of users is in possession of a second item for rental, and further comprising the steps of:
a. the facilitator establishing supplier terms with the another one of the plurality of users for renting the second item for a second specific period of time;
b. the facilitator acquiring information from some other of the plurality of users who want to rent the second item;
c. the facilitator establishing user terms with the some other of the plurality of users for renting the second item for the second specific period of time;
d. the facilitator transacting the supplier terms for renting the second item for the second specific period of time with the another one of the plurality of users;
e. the facilitator transacting the user terms for renting the second item for the second specific period of time with the some other of the plurality of users;
f. the facilitator initiating transfer of the second item directly from the another one of the plurality of users to the some other of the plurality of users; and
g. the facilitator tracking delivery of the second item from the some other of the plurality of users directly to one of the another one of the plurality of users and a different one of the plurality of users.

5. The method for transacting a commercial rental of claim 4, further comprising the step of the facilitator communicating instructions to the some other of the plurality of users identifying one of the different one of the plurality of users and the another of the plurality of users to whom delivery should be made.

6. The method for transacting a commercial rental of claim 1, further comprising the steps of:
a. the facilitator acquiring information from each supplier regarding the condition of the item prior to transfer;
b. the facilitator acquiring information from each one of the plurality of users regarding the condition of the item upon transfer; and
c. the facilitator determining a rating for each supplier based on at least one of the information from the supplier that transferred the item to the one of the plurality of users and from the one of the plurality of users regarding the condition of the item upon transfer.

7. The method for transacting a commercial rental of claim 6, further comprising the step of:
a. the facilitator determining a rating factor for each supplier based on at least one of the information from the one of the plurality of users and the information of the supplier regarding the date of transfer of the item to the one of the plurality of users.

8. The method for transacting a commercial rental of claim 1, further comprising the step of:
a. the facilitator determining a rating factor for each supplier based on at least one of the information from the one of the plurality of users and the information of the supplier regarding the date of transfer of the item to the one of the plurality of users.

9. The method for transacting a commercial rental of claim 7, wherein at least one of the rating and the rating factor is assigned a numerical value, and further comprising the steps of:
a. the facilitator determining whether the numerical value of the at least one of the rating and the rating factor varies from a numerical threshold by a predetermined amount; and
b. the facilitator restricting the transacting a commercial rental of each supplier when the numerical value of the at least one of the rating and the rating factor varies by the predetermined amount from the numerical threshold.

10. The method for transacting a commercial rental of claim 1, further comprising the steps of:
a. the facilitator acquiring information from one of the plurality of users regarding the condition of the item upon transfer;
b. the facilitator acquiring information from one of the supplier and the another of the plurality of users regarding the condition of the item upon delivery; and
c. the facilitator determining a rating for each one of the plurality of users based on at least one of the information from the one of the plurality of users and the information from the supplier or the another one of the plurality of users to whom the item was delivered regarding the condition of the item upon delivery.

11. The method for transacting a commercial rental of claim 10, further comprising the step of:
a. the facilitator determining a rating factor for each one of the plurality of users based on at least one of the information from the one of the plurality of users and the information from the supplier or the another one of the plurality of users to whom the item was delivered regarding the date of delivery.

12. The method for transacting a commercial rental of claim 11, wherein at least one of the rating and the rating factor is assigned a numerical value, and further comprising the steps of:
a. the facilitator determining whether the numerical value of the at least one of the rating and the rating factor varies by the predetermined amount from the numerical threshold; and
b. the facilitator restricting the transacting a commercial rental of each one of the plurality of users when the numerical value of the at least one of the rating and the rating factor varies by the predetermined amount from the numerical threshold.

13. The method for transacting a commercial rental of claim 1, further comprising the steps of:
a. the facilitator acquiring information from a possessor of one of the items regarding the condition of the item upon transfer;
b. the facilitator acquiring information from a successor to the possessor regarding the condition of the item upon delivery; and
c. the facilitator determining a rating for the possessor based on at least one of the information from the possessor and the information from the successor to the possessor regarding the condition of the item upon delivery.

14. The method for transacting a commercial rental of claim 13, further comprising the step of:
a. the facilitator determining a rating factor for each possessor based on at least one of the information from the possessor and the information from the successor to the possessor regarding the date of delivery.

15. The method for transacting a commercial rental of claim 14, wherein at least one of the rating and the rating factor is assigned a numerical value, and further comprising the steps of:
a. the facilitator determining whether the numerical value of the at least one of the rating and the rating factor for the transactions of each possessor varies by a predetermined amount from a numerical threshold; and
b. the facilitator restricting the transacting a commercial rental of each possessor based on at least one of the information from the possessor and the information from the successor to the possessor when the numerical value of the at least one of the rating and the rating factor varies by the predetermined amount from the numerical threshold.

16. The method for transacting a commercial rental of claim 1, further comprising the step of the another of the plurality of users assessing the condition of the item upon delivery and rating the condition.

17. The method for transacting a commercial rental of claim 1, wherein the transfer of the at least one item directly from each supplier to each one of the plurality of users is independent of the facilitator maintaining a physical inventory of the item.

18. The method for transacting a commercial rental of claim 16, wherein the delivery of the at least one item directly from one of the plurality of users to another of the plurality of users is independent of the facilitator maintaining a physical inventory of the item.

19. The method for transacting a commercial rental of claim 1, wherein the transfer of the at least one item directly from each supplier to each one of the plurality of users is independent of an ongoing subscription between the facilitator and either of the at least one of the plurality of users or the one or more suppliers.

20. The method for transacting a commercial rental of claim 1, wherein:
a. the items comprise books that are assigned by one or more designators, and
b. each one or more suppliers is one of a book publisher, a book distributor, a book retailer, a library, a business and an individual book owner; and
c. further comprising the step of the facilitator acquiring information from the one or more designators regarding the books that are assigned.

21. The method for transacting a commercial rental of claim 20, wherein the books comprise textbooks and each of the one or more designators is one of a school, a teacher and one of the plurality of users.

22. The method for transacting a commercial rental of claim 21, further comprising the step of
a. the facilitator acquiring information identifying the textbooks directly from the designator.

23. A method for renting items to a plurality of users from one or more suppliers, the method comprising computer implemented steps of:
a. acquiring information of each one or more suppliers who is in possession of at least one of the items;
b. establishing supplier terms with each supplier for renting the at least one item for a specific period of time;
c. acquiring information from each one of the plurality of users who wants to rent the at least one item;
d. establishing user terms with each user for renting the at least one item for a specific period of time;
e. transacting the supplier terms for renting the at least one item for the specific period of time with each supplier;
f. transacting the user terms for renting the at least one item for the specific period of time with each one of the plurality of users; and
g. initiating transfer of the at least one item directly from each supplier to each one of the plurality of users.

24. The method for renting items to a plurality of users of claim 23, further comprising computer implemented step of tracking delivery of each of the at least one item from each one of the plurality of users directly to one of the supplier that transferred the at least one item and another one of the plurality of users.

25. The method for renting items to a plurality of users of claim 23, wherein the user terms includes an option for each user to purchase the at least one item, and further comprising the step of transacting the user terms for selling the at least one item with each one of the plurality of users that elected to purchase the at least one item in lieu of transacting the user terms for renting the at least one item for the specific period of time with each one of the plurality of users that elected to purchase the at least one item.

26. The method for renting items to a plurality of users of claim 23, further comprising computer implemented step of communicating instructions to each one of the plurality of users identifying one of the supplier and another one of the plurality of users to whom delivery should be made.

27. The method for renting items to a plurality of users of claim 23, wherein at least one of the one or more suppliers is one of the plurality of users.

28. The method for renting items to a plurality of users of claim 23, wherein the another one of the plurality of users is in possession of a second item for rental, and further comprising computer implemented steps of:
a. establishing supplier terms with the another one of the plurality of users for renting the second item for a second specific period of time;
b. acquiring information from some other of the plurality of users who want to rent the second item;
c. establishing user terms with the some other of the plurality of users for renting the second item for the second specific period of time;
d. transacting the supplier terms for renting the second item for the second specific period of time with the another one of the plurality of users;
e. transacting the user terms for renting the second item for the second specific period of time with the some other of the plurality of users;
f. initiating transfer of the second item directly from the another one of the plurality of users to the some other of the plurality of users; and
g. tracking delivery of the second item from the some other of the plurality of users directly to one of the another one of the plurality of users and a different one of the plurality of users.

29. The method for renting items to a plurality of users of claim 23, further comprising the computer implemented step of communicating instructions to the some other of the plurality of users identifying one of the different one of the plurality of users and the another of the plurality of users to whom delivery should be made.

30. The method for renting items to a plurality of users of claim 23, further comprising the computer implemented steps of:
a. acquiring information from each supplier regarding the condition of the item prior to transfer;
b. acquiring information from each one of the plurality of users regarding the condition of the item upon transfer; and
c. determining a rating for a transaction involving each supplier based on at least one of the information from the supplier that transferred the item to the one of the plurality of users and the one of the plurality of users regarding the condition of the item upon transfer.

31. The method for renting items to a plurality of users of claim 30, further comprising the computer implemented step of:
a. determining a rating factor for a transaction involving each supplier based on at least one of the information from the one of the plurality of users and the information of the supplier regarding the date of transfer of the item to the one of the plurality of users.

32. The method for renting items to a plurality of users of claim 23, further comprising the computer implemented step of:
a. determining a rating factor for a transaction involving each supplier based on at least one of the information from the one of the plurality of users and the information of the supplier regarding the date of transfer of the item to the one of the plurality of users.

33. The method for renting items to a plurality of users of claim 31, wherein at least one of the rating and the rating factor for the transaction is assigned a numerical value, and further comprising the computer implemented steps of:
a. determining whether a numerical value of the at least one of the rating and the rating factor for the transactions of each supplier varies by a predetermined amount from a numerical threshold; and
b. restricting the transacting a commercial rental of each supplier when the numerical value of each supplier varies by the predetermined amount from the numerical threshold.

34. The method for renting items to a plurality of users of claim 23, further comprising the computer implemented steps of:
a. acquiring information from one of the plurality of users regarding the condition of the item upon transfer;
b. acquiring information from one of the supplier and the another of the plurality of users regarding the condition of the item upon delivery; and
c. determining a rating for each one of the plurality of users based on at least one of the information from the one of the plurality of users and the information from the supplier or the another one of the plurality of users to whom the item was delivered regarding the condition of the item upon delivery.

35. The method for renting items to a plurality of users of claim 34, further comprising the computer implemented step of:
a. determining a rating factor for each one of the plurality of users based on at least one of the information from the one of the plurality of users and the information from the supplier or the another one of the plurality of users to whom the item was delivered regarding the date of delivery.

36. The method for renting items to a plurality of users of claim 35, wherein at least one of the rating and the rating factor for the transaction is assigned a numerical value, and further comprising the computer implemented steps of:
a. determining whether a numerical value of the at least one of the rating and the rating factor for the transactions of each supplier varies by a predetermined amount from a numerical threshold; and
b. restricting the transacting a commercial rental of each supplier when the numerical value of each supplier varies by the predetermined amount from the numerical threshold.

37. The method for renting items to a plurality of users of claim 23, further comprising the computer implemented steps of:
a. acquiring information from a possessor of one of the items regarding the condition of the item upon transfer;
b. acquiring information from a successor to the possessor regarding the condition of the item upon delivery; and
c. determining a rating for the possessor based on at least one of the information from the possessor and the information from the successor to the possessor regarding the condition of the item upon delivery.

38. The method for renting items to a plurality of users of claim 37, further comprising the computer implemented step of:
a. determining a rating factor for each possessor based on at least one of the information from the possessor and the information from the successor to the possessor regarding the date of delivery.

39. The method for renting items to a plurality of users of claim 38, wherein at least one of the rating and the rating factor for the transaction is assigned a numerical value, and further comprising the computer implemented steps of:
a. determining whether a numerical value of the at least one of the rating and the rating factor for the transactions of each supplier varies by a predetermined amount from a numerical threshold; and
b. restricting the transacting a commercial rental of each supplier when the numerical value of each supplier varies by the predetermined amount from the numerical threshold.

40. The method for renting items to a plurality of users of claim 23, further comprising the computer implemented step of the another of the plurality of users assessing the condition of the item upon delivery and rating the condition.

41. The method for renting items to a plurality of users of claim 23, wherein the transfer of the at least one item directly from each supplier to each one of the plurality of users is independent of maintaining a physical inventory of the at least one item.

42. The method for renting items to a plurality of users of claim 23, wherein the transfer of the at least one item directly from each supplier to each one of the plurality of users is independent of an ongoing subscription with the plurality of users.

43. The computer implemented method for renting items to a plurality of users of claim 23, wherein:
a. the items comprise books that are assigned by one or more designators, and
b. each one or more suppliers is one of a book publisher, a book distributor, a book retailer, a library, a business and an individual book owner; and
c. further comprising the step of acquiring information from the one or more designators regarding the books that are assigned.

44. The computer implemented method for renting items to a plurality of users of claim 43, wherein the books comprise textbooks and each of the one or more designators is one of a school, a teacher and one of the plurality of users.

45. The method for renting items to a plurality of users of claim 44, further comprising the computer implemented step of acquiring information identifying the textbooks directly from the designator.

46. A computer-readable medium for renting items to a plurality of users from one or more suppliers, the computer-readable medium carrying one or more sequences of one or more instructions which, when executed by one or more processors, cause the one or more processors to perform the computer-implemented steps of:
a. acquiring information of each one or more suppliers who is in possession of at least one of the items;
b. establishing supplier terms with each supplier for renting the at least one item for a specific period of time;
c. acquiring information from each one of the plurality of users who wants to rent the at least one item;
d. establishing user terms with each user for renting the at least one item for a specific period of time;
e. transacting the supplier terms for renting the at least one item for the specific period of time with each supplier;
f. transacting the user terms for renting the at least one item for the specific period of time with each one of the plurality of users;
g. initiating transfer of the at least one item directly from each supplier to each one of the plurality of users; and
h. tracking delivery of each of the at least one item from each one of the plurality of users directly to one of the supplier that transferred the at least one item and another one of the plurality of users.

47. The computer-readable medium for renting items to a plurality of users of claim 46, further comprising one or more sequences of one or more instructions which, when executed by the one or more processors, cause the one or more processors to perform the step of communicating instructions to each one of the plurality of users identifying one of the supplier and another one of the plurality of users to whom delivery should be made.

48. The computer-readable medium for renting items to a plurality of users of claim 46, wherein at least one of the one or more suppliers is one of the plurality of users.

49. The computer-readable medium for renting items to a plurality of users of claim 46, wherein the another one of the plurality of users is in possession of a second item for rental, and further comprising one or more sequences of one or more instructions which, when executed by the one or more processors, cause the one or more processors to perform the steps of:
a. establishing supplier terms with the another one of the plurality of users for renting the second item for a second specific period of time;
b. acquiring information from some other of the plurality of users who want to rent the second item;
c. establishing user terms with the some other of the plurality of users for renting the second item for the second specific period of time;
d. transacting the supplier terms for renting the second item for the second specific period of time with the another one of the plurality of users;
e. transacting the user terms for renting the second item for the second specific period of time with the some other of the plurality of users;
f. initiating transfer of the second item directly from the another one of the plurality of users to the some other of the plurality of users; and
g. tracking delivery of the second item from the some other of the plurality of users directly to one of the another one of the plurality of users and a different one of the plurality of users.

50. The computer-readable medium for renting items to a plurality of users of claim 46, further comprising one or more sequences of one or more instructions which, when executed by the one or more processors, cause the one or more processors to perform the step of communicating instructions to the some other of the plurality of users identifying one of the different one of the plurality of users and the another of the plurality of users to whom delivery should be made.

51. The computer-readable medium for renting items to a plurality of users of claim 46, further comprising one or more sequences of one or more instructions which, when executed by the one or more processors, cause the one or more processors to perform the steps of:
a. acquiring information from each supplier regarding the condition of the item prior to transfer;
b. acquiring information from each one of the plurality of users regarding the condition of the item upon transfer; and
c. determining a rating for each supplier based on at least one of the information from the supplier that transferred the item to the one of the plurality of users and the one of the plurality of users regarding the condition of the item upon transfer.

52. The computer-readable medium for renting items to a plurality of users of claim 51, further comprising one or more sequences of one or more instructions which, when executed by the one or more processors, cause the one or more processors to perform the step of:
a. determining a rating factor for each supplier based on at least one of the information from the one of the plurality of users and the information of the supplier regarding the date of transfer of the item to the one of the plurality of users.

53. The computer-readable medium for renting items to a plurality of users of claim 46, further comprising one or more sequences of one or more instructions which, when executed by the one or more processors, cause the one or more processors to perform the step of:
a. determining a rating factor for each supplier based on at least one of the information from the one of the plurality of users and the information of the supplier regarding the date of transfer of the item to the one of the plurality of users.

54. The computer-readable medium for renting items to a plurality of users of claim 52, wherein at least one of the rating and the rating factor for the transaction is assigned a numerical value, and further comprising one or more sequences of one or more instructions which, when executed by the one or more processors, cause the one or more processors to perform the steps of:
a. determining whether a numerical value of the at least one of the rating and the rating factor for the transactions of each supplier varies by a predetermined amount from a numerical threshold; and
b. restricting the transacting a commercial rental of each supplier when the numerical value of each supplier varies by the predetermined amount from the numerical threshold.

55. The computer-readable medium for renting items to a plurality of users of claim 46, further comprising one or more sequences of one or more instructions which, when executed by the one or more processors, cause the one or more processors to perform the steps of:
a. acquiring information from one of the plurality of users regarding the condition of the item upon transfer;
b. acquiring information from one of the supplier and the another of the plurality of users regarding the condition of the item upon delivery; and
c. determining a rating for each one of the plurality of users based on at least one of the information from the one of the plurality of users and the information from the supplier or the another one of the plurality of users to whom the item was delivered regarding the condition of the item upon delivery.

56. The computer-readable medium for renting items to a plurality of users of claim 55, further comprising one or more sequences of one or more instructions which, when executed by the one or more processors, cause the one or more processors to perform the step of:
a. determining a rating factor for each one of the plurality of users based on at least one of the information from the one of the plurality of users and the information from the supplier or the another one of the plurality of users to whom the item was delivered regarding the date of delivery.

57. The computer-readable medium for renting items to a plurality of users of claim 56, wherein at least one of the rating and the rating factor for the transaction is assigned a numerical value, and further comprising one or more sequences of one or more instructions which, when executed by the one or more processors, cause the one or more processors to perform the steps of:
a. determining whether a numerical value of the at least one of the rating and the rating factor for the transactions of each supplier varies by a predetermined amount from a numerical threshold; and
b. restricting the transacting a commercial rental of each supplier when the numerical value of each supplier varies by the predetermined amount from the numerical threshold.

58. The computer-readable medium for renting items to a plurality of users of claim 46, further comprising one or more sequences of one or more instructions which, when executed by the one or more processors, cause the one or more processors to perform the steps of:
a. acquiring information from a possessor of one of the items regarding the condition of the item upon transfer;
b. acquiring information from a successor to the possessor regarding the condition of the item upon delivery; and
c. determining a rating for the possessor based on at least one of the information from the possessor and the information from the successor to the possessor regarding the condition of the item upon delivery.

59. The computer-readable medium for renting items to a plurality of users of claim 58, further comprising one or more sequences of one or more instructions which, when executed by the one or more processors, cause the one or more processors to perform the step of:
a. determining a rating factor for each possessor based on at least one of the information from the possessor and the information from the successor to the possessor regarding the date of delivery.

60. The computer-readable medium for renting items to a plurality of users of claim 59, wherein at least one of the rating and the rating factor for the transaction is assigned a numerical value, and further comprising one or more sequences of one or more instructions which, when executed by the one or more processors, cause the one or more processors to perform the steps of:
a. determining whether a numerical value of the at least one of the rating and the rating factor for the transactions of each supplier varies by a predetermined amount from a numerical threshold; and
b. restricting the transacting a commercial rental of each supplier based on at least one of the information from the possessor and the information from the successor to the possessor when the numerical value of each supplier varies by the predetermined amount from the numerical threshold.

61. The computer-readable medium for renting items to a plurality of users of claim 46, further comprising one or more sequences of one or more instructions which, when executed by the one or more processors, cause the one or more processors to perform the step of the another of the plurality of users assessing the condition of the item upon delivery and rating the condition.

62. The computer-readable medium for renting items to a plurality of users of claim 46, wherein the transfer of the at least one item directly from each supplier to each one of the plurality of users is independent of maintaining a physical inventory of the item.

63. The computer-readable medium for renting items to a plurality of users of claim 46, wherein the transfer of the at least one item directly from each supplier to each one of the plurality of users is independent of an ongoing subscription with the plurality of users.

64. The computer-readable medium for renting items to a plurality of users of claim 46, wherein:
a. the items comprise books that are assigned by one or more designators, and
b. each one or more suppliers is one of a book publisher, a book distributor, a book retailer, a library, a business and an individual book owner; and
c. further comprising one or more sequences of one or more instructions which, when executed by the one or more processors, cause the one or more processors to perform the step of acquiring information from the one or more designators regarding the books that are assigned.

65. The computer-readable medium for renting items to a plurality of users of claim 64, wherein the books comprise textbooks and each of the one or more designators is one of a school, a teacher and one of the plurality of users.

66. The computer-readable medium for renting items to a plurality of users of claim 65, further comprising one or more sequences of one or more instructions which, when executed by the one or more processors, cause the one or more processors to perform the step of:
a. acquiring information identifying the textbooks directly from the designator.

67. An apparatus for renting items to a plurality of users from one or more suppliers comprising:
a. one or more processors; and
b. a memory communicatively coupled to the one or more processors, the memory including one or more sequences of one or more instructions which, when executed by one or more processors, cause the one or more processors to perform the steps of:
i. acquiring information of each one or more suppliers who is in possession of at least one of the items,
ii. establishing supplier terms with each supplier for renting the at least one item for a specific period of time,
iii. acquiring information from each one of the plurality of users who wants to rent the at least one item,
iv. establishing user terms with each user for renting the at least one item for a specific period of time,
v. transacting the supplier terms for renting the at least one item for the specific period of time with each supplier,
vi. transacting the user terms for renting the at least one item for the specific period of time with each one of the plurality of users,
vii. initiating transfer of the at least one item directly from each supplier to each one of the plurality of users, and
viii. tracking delivery of each of the at least one item from each one of the plurality of users directly to one of the supplier that transferred the at least one item and another one of the plurality of users.

68. The apparatus for renting items to a plurality of users of claim 67, wherein the memory further comprises one or more sequences of one or more instructions which, when executed by the one or more processors, cause the one or more processors to perform the step of communicating instructions to each one of the plurality of users identifying one of the supplier and another one of the plurality of users to whom delivery should be made.

69. The apparatus for renting items to a plurality of users of claim 67, wherein at least one of the one or more suppliers is one of the plurality of users.

70. The apparatus for renting items to a plurality of users of claim 67, wherein the another one of the plurality of users is in possession of a second item for rental, and wherein the memory further comprises one or more sequences of one or more instructions which, when executed by the one or more processors, cause the one or more processors to perform the steps of:
a. establishing supplier terms with the another one of the plurality of users for renting the second item for a second specific period of time;
b. acquiring information from some other of the plurality of users who want to rent the second item;
c. establishing user terms with the some other of the plurality of users for renting the second item for the second specific period of time;
d. transacting the supplier terms for renting the second item for the second specific period of time with the another one of the plurality of users;
e. transacting the user terms for renting the second item for the second specific period of time with the some other of the plurality of users;
f. initiating transfer of the second item directly from the another one of the plurality of users to the some other of the plurality of users; and
g. tracking delivery of the second item from the some other of the plurality of users directly to one of the another one of the plurality of users and a different one of the plurality of users.

71. The apparatus for renting items to a plurality of users of claim 67, wherein the memory further comprises one or more sequences of one or more instructions which, when executed by the one or more processors, cause the one or more processors to perform the step of communicating instructions to the some other of the plurality of users identifying one of the different one of the plurality of users and the another of the plurality of users to whom delivery should be made.

72. The apparatus for renting items to a plurality of users of claim 67, wherein the memory further comprises one or more sequences of one or more instructions which, when executed by the one or more processors, cause the one or more processors to perform the steps of:
a. acquiring information from each supplier regarding the condition of the item prior to transfer;
b. acquiring information from each one of the plurality of users regarding the condition of the item upon transfer; and
c. determining a rating for each supplier based on at least one of the information from the supplier that transferred the item to the one of the plurality of users and the one of the plurality of users regarding the condition of the item upon transfer.

73. The apparatus for renting items to a plurality of users of claim 72, wherein the memory further comprises one or more sequences of one or more instructions which, when executed by the one or more processors, cause the one or more processors to perform the step of:
a. determining a rating factor for each supplier based on at least one of the information from the one of the plurality of users and the information of the supplier regarding the date of transfer of the item to the one of the plurality of users.

74. The apparatus for renting items to a plurality of users of claim 67, wherein the memory further comprises one or more sequences of one or more instructions which, when executed by the one or more processors, cause the one or more processors to perform the step of:
a. determining a rating factor for each supplier based on at least one of the information from the one of the plurality of users and the information of the supplier regarding the date of transfer of the item to the one of the plurality of users.

75. The apparatus for renting items to a plurality of users of claim 73, wherein at least one of the rating and the rating factor is assigned a numerical value, and wherein the memory further comprises one or more sequences of one or more instructions which, when executed by the one or more processors, cause the one or more processors to perform the steps of:
a. determining whether a numerical value of the at least one of the rating and the rating factor for the transactions of each supplier varies by a predetermined amount from a numerical threshold; and
b. restricting the transacting a commercial rental of each supplier when the numerical value of each supplier varies by the predetermined amount from the numerical threshold.

76. The apparatus for renting items to a plurality of users of claim 67, wherein the memory further comprises one or more sequences of one or more instructions which, when executed by the one or more processors, cause the one or more processors to perform the steps of:
a. acquiring information from one of the plurality of users regarding the condition of the item upon transfer;
b. acquiring information from one of the supplier and the another of the plurality of users regarding the condition of the item upon delivery; and
c. determining a rating for each one of the plurality of users based on at least one of the information from the one of the plurality of users and the information from the supplier or the another one of the plurality of users to whom the item was delivered regarding the condition of the item upon delivery.

77. The apparatus for renting items to a plurality of users of claim 76, wherein the memory further comprises one or more sequences of one or more instructions which, when executed by the one or more processors, cause the one or more processors to perform the step of:
a. determining a rating factor for each one of the plurality of users based on at least one of the information from the one of the plurality of users and the information from the supplier or the another one of the plurality of users to whom the item was delivered regarding the date of delivery.

78. The apparatus for renting items to a plurality of users of claim 77, wherein at least one of the rating and the rating factor is assigned a numerical value, and wherein the memory further comprises one or more sequences of one or more instructions which, when executed by the one or more processors, cause the one or more processors to perform the steps of:
a. determining whether a numerical value of the at least one of the rating and the rating factor for the transactions of each supplier varies by a predetermined amount from a numerical threshold; and
b. restricting the transacting of a commercial rental of each supplier when the numerical value of said supplier varies by the predetermined amount from the numerical threshold.

79. The apparatus for renting items to a plurality of users of claim 67, wherein the memory further comprises one or more sequences of one or more instructions which, when executed by the one or more processors, cause the one or more processors to perform the steps of:
a. acquiring information from a possessor of one of the items regarding the condition of the item upon transfer;
b. acquiring information from a successor to the possessor regarding the condition of the item upon delivery; and
c. determining a rating for the possessor based on at least one of the information from the possessor and the information from the successor to the possessor regarding the condition of the item upon delivery.

80. The apparatus for renting items to a plurality of users of claim 79, wherein the memory further comprises one or more sequences of one or more instructions which, when executed by the one or more processors, cause the one or more processors to perform the step of:
a. determining a rating factor for each possessor based on at least one of the information from the possessor and the information from the successor to the possessor regarding the date of delivery.

81. The apparatus for renting items to a plurality of users of claim 80, wherein at least one of the rating and the rating factor is assigned a numerical value, and wherein the memory further comprises one or more sequences of one or more instructions which, when executed by the one or more processors, cause the one or more processors to perform the steps of:
a. determining whether the numerical value of the at least one of the rating and the rating factor varies by the predetermined amount from the numerical threshold; and
b. restricting the transacting a commercial rental of each based on at least one of the information from the possessor and the information from the successor to the possessor when the numerical value of the at least one of the rating and the rating factor varies by the predetermined amount from the numerical threshold.

82. The apparatus for renting items to a plurality of users of claim 67, wherein the memory further comprises one or more sequences of one or more instructions which, when executed by the one or more processors, cause the one or more processors to perform the step of the another of the plurality of users assessing the condition of the item upon delivery and rating the condition.

83. The apparatus for renting items to a plurality of users of claim 67, wherein the transfer of the at least one item directly from each supplier to each one of the plurality of users is independent of maintaining a physical inventory of the item.

84. The apparatus for renting items to a plurality of users of claim 67, wherein the transfer of the at least one item directly from each supplier to each one of the plurality of users is independent of an ongoing subscription with the plurality of users.

85. The apparatus for renting items to a plurality of users of claim 67, wherein:
a. the items comprise books that are assigned by one or more designators, and
b. each one or more suppliers is one of a book publisher, a book distributor, a book retailer, a library, a business and an individual book owner; and
c. wherein the memory further comprises one or more sequences of one or more instructions which, when executed by the one or more processors, cause the one or more processors to perform the step of acquiring information from the one or more designators regarding the books that are assigned.

86. The apparatus for renting items to a plurality of users of claim 85, wherein the books comprise textbooks and each of the one or more designators is one of a school, a teacher and one of the plurality of users.

87. The apparatus for renting items to a plurality of users of claim 86, wherein the memory further comprises one or more sequences of one or more instructions which, when executed by the one or more processors, cause the one or more processors to perform the step of:
a. acquiring information identifying the textbooks directly from the designator.

88. An apparatus for renting items to a plurality of users from one or more suppliers comprising an item rental mechanism, with information of each one or more suppliers who is in possession of at least one of the items and are willing to rent the at least one of the items for a specific period of time under predetermined supplier terms, configured to:
a. acquire information from each one of the plurality of users who wants to rent the at least one item;
b. communicate user terms with each user for renting the at least one item for the specific period of time;
c. transact the user terms for renting the at least one item for the specific period of time between a facilitator and each one of the plurality of users; and
d. in response to transacting the user terms for renting the at least one item for the specific period of time, transacting the supplier terms for renting the at least one item for the specific period of time with each supplier and initiating transfer of the at least one item directly from each supplier to each one of the plurality of users.

89. The apparatus for renting items to a plurality of users of claim 88, wherein the item rental mechanism is further configured to track delivery of each of the at least one item from each one of the plurality of users directly to one of the supplier that transferred the at least one item and another one of the plurality of users.

90. The apparatus for renting items to a plurality of users of claim 89, wherein the item rental mechanism is further configured to communicate instructions to each one of the plurality of users identifying one of the supplier and another one of the plurality of users to whom delivery should be made.

91. The apparatus for renting items to a plurality of users of claim 88, wherein the item rental mechanism is further configured to transfer the at least one item directly from each supplier to each one of the plurality of users independent of maintaining a physical inventory of the item.

92. The apparatus for renting items to a plurality of users of claim 88, wherein the item rental mechanism is further configured to transfer the at least one item directly from each supplier to each one of the plurality of users independent of an ongoing subscription with the plurality of users.

93. A rental and distribution network for textbooks assigned by one or more designators, through at least one internet compatible server for each one or more designators, to a plurality of users, through at least one device coupled to the internet for each of said plurality of users, from one or more suppliers, through an internet compatible system for each of the one or more suppliers, comprising a computer system having one or more processors and a memory communicatively coupled to the one or more processors, the memory including one or more sequences of one or more instructions which, when executed by one or more processors, cause the one or more processors to perform the steps of:
a. acquiring information from the at least one internet compatible server for each one or more designators identifying at least one textbook required to be used by a student attending a particular class;
b. acquiring information from the internet compatible system of each one or more suppliers who is in possession of the at least one textbook;
c. acquiring information from the at least one device of each one of the plurality of users who wants to rent the at least one textbook; and
d. initiating transfer of the at least one textbook directly from each supplier to each one of the plurality of users who wants to rent the at least one textbook.

94. The rental and distribution network for textbooks of claim 93, wherein the memory further includes one or more sequences of one or more instructions which, when executed by one or more processors, cause the one or more processors to perform the steps of:
a. communicating instructions to each one of the plurality of users who rented the at least one textbook regarding delivery to one of the supplier that transferred the who wants to rent the at least one textbook and another one of the plurality of users; and
b. tracking delivery of each of the at least one textbook from each one of the plurality of users directly to one of the supplier that transferred the who wants to rent the at least one textbook and another one of the plurality of users.

95. The rental and distribution network for textbooks of claim 93, wherein at least one of the one or more suppliers is one of the plurality of users.

96. The rental and distribution network for textbooks of claim 93, wherein the memory further comprises one or more sequences of one or more instructions which, when executed by the one or more processors, cause the one or more processors to perform the steps of:
a. establishing supplier terms with each supplier for renting the at least one textbook for a specific period of time;
b. establishing user terms with each user for renting the at least one textbook for a specific period of time;
c. transacting the supplier terms for renting the at least one textbook for the specific period of time with each supplier; and
d. transacting the user terms for renting the at least one textbook for the specific period of time with each one of the plurality of users.

97. The rental and distribution network for textbooks of claim 96, wherein the another one of the plurality of users is in possession of a second textbook for rental, and wherein the memory further comprises one or more sequences of one or more instructions which, when executed by the one or more processors, cause the one or more processors to perform the steps of:
a. establishing supplier terms with the another one of the plurality of users for renting the second textbook for a second specific period of time;
b. acquiring information from some other of the plurality of users who want to rent the second textbook;
c. initiating transfer of the second textbook directly from the another one of the plurality of users to the some other of the plurality of users; and
d. tracking delivery of the second textbook from the some other of the plurality of users directly to one of the another one of the plurality of users and a different one of the plurality of users.
